(19) United States
(12) Patent Application Publication
(10) Pub. No.: US 2022/0305525 A1
(43) Pub. Date: Sep. 29, 2022

(54) COATING METHOD AND BODY OF AUTOMOBILE

(71) Applicant: HONDA MOTOR CO., LTD., Tokyo (JP)

(72) Inventors: Masayuki Yamaguchi, Tokyo (JP); Yoshitaka Tsujii, Tokyo (JP); Mitsuya Murata, Tokyo (JP)

(21) Appl. No.: 17/673,895

(22) Filed: Feb. 17, 2022

(30) Foreign Application Priority Data
Mar. 23, 2021 (JP) 2021-048582

(51) Int. Cl. B05D 3/00; B60R 19/03; B60R 19/04; B29C 65/14; B29C 65/00; B05D 3/06

(52) U.S. Cl. CPC B05D 3/002; B60R 19/03; B60R 19/04; B29C 65/1403; B29C 66/72321; B05D 3/068; B05D 2201/02; B05D 2350/00; B29L 2031/3044

(57) ABSTRACT

A coating method comprises a workpiece acquiring step of acquiring a workpiece in which a metal member and a resin member the surface of which is activated by electron beam irradiation are connected to each other, and a coating step of applying a coating material to the metal member and the resin member of the workpiece.

### CROSS-REFERENCE TO RELATED APPLICATIONS

This application is based upon and claims the benefit of priority from Japanese Patent Application No. 2021-048582 filed on Mar. 23, 2021 the contents of which are incorporated herein by reference.

### BACKGROUND OF THE INVENTION

### Field of the Invention

The present invention relates to a coating method and a body of an automobile.

### Description of the Related Art

There is a case where a workpiece made up from a combination of a metal member and a resin member is coated. For example, in the case of an automobile, it is often seen that a body itself is made up from a metal material but a bumper attached to the body is made up from a resin material.

Here, the resin material includes a material having a low affinity with coating material (hereinafter referred to as “low-affinity material”). Examples of low-affinity material include polypropylene and nylon. Since the coating material applied to the resin member of low-affinity material does not have good adhesion to the resin member, the coating material easily peels off from the resin member. Therefore, when coating material is applied to the resin member of low affinity material, a base material (for example, a primer) having a high affinity with the coating material is often applied to the resin member before the coating material is applied to the resin member. In this case, coating of the resin member requires application of a primer to the resin member. Accordingly, it is not easy to coat the metal member and the resin member in the same process.

JP 4964021 B2 discloses a technique for improving the adhesion of an antifouling layer to a substrate by treating the substrate with corona discharge before forming the antifouling layer. However, the technique disclosed in JP 4964021 B2 is not intended to be applied to a workpiece formed by combining a metal member and a resin member, nor is it intended to be applied to the low-affinity material.

### SUMMARY OF THE INVENTION

It is desired to coat a workpiece produced by combining a metal member and a resin member without a primer. An object of the present invention is to solve the above-mentioned problem.

A coating method according to one aspect of the present invention includes a work acquiring step of acquiring a workpiece in which a metal member and a resin member a surface of which has been activated by electron beam irradiation are connected to each other, and a coating step of applying a coating material to the metal member and the resin member of the workpiece.

A body of an automobile according to one aspect of the present invention includes a metal body, a bumper attached to the metal body and made up from a resin member, and a coating film covering the metal body and the bumper, wherein the bumper includes a surface-activated layer in which a surface of the resin member has been activated, and the coating film is directly deposited on the surface-activated layer.

According to the present invention, it is possible to provide and a body of an automobile and a coating method capable of coating a workpiece produced by combining a metal member and a resin member without using a primer.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a view showing a coating system according to an embodiment.

FIGS. 2A and 2B are views showing details of an electron beam irradiation facility according to an example.

FIGS. 3A and 3B are views showing details of an electron beam irradiation facility according to another example.

FIG. 4 is a view showing details of an electron beam irradiation facility according to still another example.

FIG. 5 is a flow chart showing a coating method according to an embodiment.

FIG. 6 is a flow chart showing a coating method according to a second modification.

### DESCRIPTION OF THE INVENTION

Hereinafter, a coating method and a body of an automobile according to an embodiment of the present invention will be described.

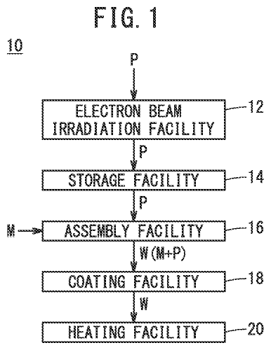

FIG. 1 shows a coating system 10 according to an embodiment of the present invention. The coating system 10 is a system for coating a workpiece W. The coating system 10 includes an electron beam irradiation facility 12, a storage facility 14, an assembly facility 16, a coating facility 18, and a heating facility 20.

First, a general flow of processes in the coating system 10 will be described. That is, a resin member P is transferred to the electron beam irradiation facility 12 for processing. Thereafter, the resin member P is transferred to the storage facility 14 for processing. Further, the resin member P is transferred to the assembly facility 16 and assembled to a metal member M. That is, a workpiece W in which the resin member P and the metal member M are combined is produced. The produced work W is transferred to the coating facility 18 and the heating facility 20 and is processed sequentially.

The workpiece W is, for example, a body of an automobile. The workpiece W is formed by connecting the metal member M (e.g., a metal body of an automobile) and the resin member P (e.g., a bumper of the automobile) to each other. In many cases, the bumper is made up from a low-affinity material having a low affinity for a coating material such as polypropylene. In such a case, generally, before the resin member P is coated with a coating material, a base material (primer) having a high affinity with the coating material is applied to the resin member P, and the applied primer is dried. However, the application and drying of the primer are required only for the resin member P and not for the metal member M. Therefore, it becomes difficult to process the metal member M and the resin member P in the same process. The application and drying of the primer also requires material and electric power. Furthermore, the application and drying of the primer requires a section (booth) for these operations. Thus, the application and drying of the primer is not preferable from the viewpoints of energy saving and space saving. As described below, this embodiment uses an electron beam, thereby eliminating the need for a primer. Thus, the metal member M and the resin member P can be processed in the same process.

The electron beam irradiation facility 12 activates the surface of the resin member P by irradiating the resin member P with electron beams. By irradiating the resin member P with electron beams, a surface-activated layer is formed on the surface of the resin member P. The surface-activated layer has hydroxy groups bonded to carbon atoms constituting the resin material. That is, the resin material is irradiated with electron beams, whereby saturated-state bonds between carbon atoms constituting the resin material are cleaved into double bonds. Oxygen (O₂) in the environment (for example, the atmosphere in the irradiation area A described later) reacts with the cleaved double bonds. Thereby, hydroxy groups as an active group are added to the carbon atoms constituting the resin material. As a result, a plurality of hydroxy groups are arranged along the surface of the resin member P. Since the surface-activated layer has active groups, the surface-activated layer has good wettability with the coating material, large intermolecular force, and good adhesion with the coating film.

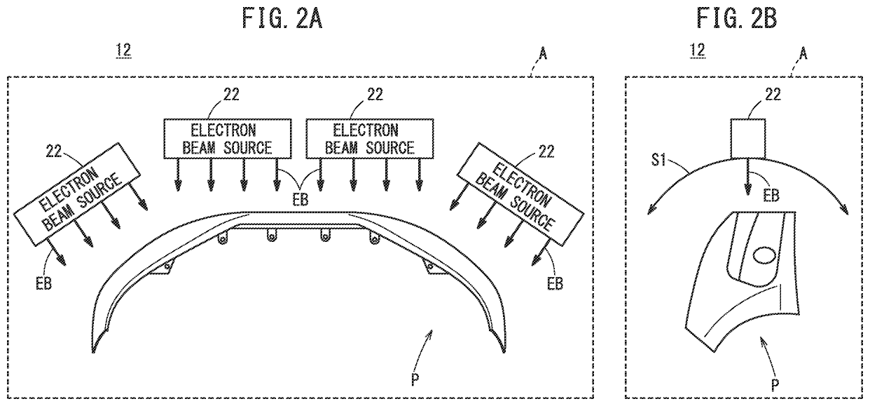

FIGS. 2A and 2B are views showing details of the electron beam irradiation facility 12 according to an example. The electron beam irradiation facility 12 has the irradiation area A for irradiating the resin member P with electron beams EB. The irradiation area A may be under normal atmospheric conditions. Thus, the oxygen concentration in the irradiation area A can be set to be suitable for activation of the resin member P with the electron beam EB. However, the oxygen concentration within the irradiation area A may be increased or decreased with respect to the oxygen concentration in the atmosphere.

In order to allow the resin member P to enter and leave the irradiation area A, the electron beam irradiation facility 12 has an entrance and an exit (not shown). Examples of the entrance and the exit can include shutters, and either ridge-type or fold-type open/close units. FIG. 2A shows the electron beam irradiation facility 12 viewed from the front of the entrance of the irradiation area A. FIG. 2B shows the electron beam irradiation facility 12 viewed from the lateral direction of the entrance of the irradiation area A.

The electron beam irradiation facility 12 has a plurality of electron beam sources 22. Each of the plurality of electron beam sources 22 generates a plurality of electron beams EB, accelerates the generated electron beams EB, and further irradiates the resin member P with the accelerated electron beams EB. Each electron beam source 22 has a longitudinal shape. A plurality of emission ports for the electron beam EB are arranged on each electron beam source 22 along the longitudinal direction thereof. Thus, each electron beam source 22 can emit a plurality of electron beams EB. The electron beam irradiation facility 12 also includes a plurality of drive mechanisms (not shown) and one control unit (not shown). Each drive mechanism changes the position and orientation of the corresponding electron beam source 22. The control unit controls the plurality of electron beam sources 22 and the plurality of drive mechanisms.

As shown in FIG. 2A, a plurality (here, four) of electron beam sources 22 are arranged along the longitudinal direction of the resin member P (here, the bumper). At each of the plurality of electron beam sources 22, a plurality of emission ports for the electron beam EB are arranged in a row in the arrangement direction along the longitudinal direction of the resin member P. Thus, each of the electron beam sources 22 can emit a plurality of electron beams EB along the longitudinal direction of the resin member P. As shown in FIG. 2B, the plurality of electron beam sources 22 move on a line S1. The line S1 extends along the surface of the resin member P and in the shorter direction of the resin member P. Thus, the electron beam irradiation facility 12 can irradiate the entire surface of the resin member P with the electron beams EB. For the sake of simplicity, FIG. 2B omits part of the system. That is, in FIG. 2B, a plurality of overlapped electron beam sources 22 (and a plurality of electron beams EB) are omitted, and only one electron beam source 22 (and one electron beam EB) is shown.

In this manner, the plurality of electron beam sources 22 are arranged such that a plurality of electron beams EB are emitted along the longitudinal direction of the resin member P. Further, the plurality of electron beam sources 22 move along the shorter direction of the resin member P. Thus, the electron beam irradiation facility 12 can irradiate the entire surface of the resin member P with the electron beams EB.

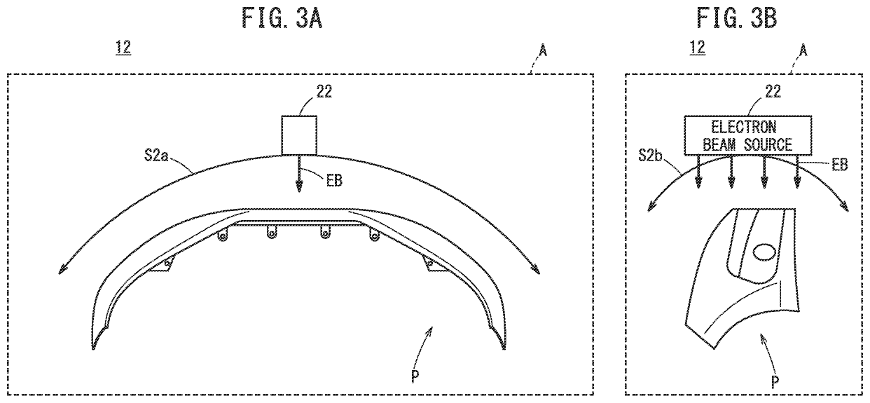

FIGS. 3A and 3B are diagrams showing details of an electron beam irradiation facility 12 according to another example. FIG. 3A represents the electron beam irradiation facility 12 as viewed from the front of the entrance of the irradiation area A, and corresponds to FIG. 2A. FIG. 3B shows the electron beam irradiation facility 12 as viewed from the side of the entrance of the irradiation area A, and corresponds to FIG. 2B.

As shown in FIGS. 3A and 3B, here, the electron beam irradiation facility 12 has one electron beam source 22. At this electron beam source 22, a plurality of emission ports for the electron beam EB are arranged in a row in the arrangement direction along the shorter direction of the resin member P. Further, the electron beam source 22 moves on a line S2a in the longitudinal direction of the resin member P and moves on a line S2b in the shorter direction of the resin member P. That is, the electron beam source 22 moves along a curved surface that curves along the surface of the resin member P. Thus, the electron beam irradiation facility 12 can irradiate the entire surface of the resin member P with the electron beams EB.

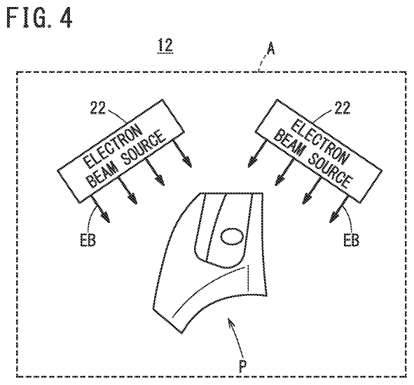

FIG. 4 is a diagram showing details of an electron beam irradiation facility 12 according to still another example. FIG. 4 shows the electron beam irradiation facility 12 as viewed from the side of the entrance of the irradiation area A, and corresponds to FIGS. 2B and 3B. As shown in FIG. 4, a plurality of (here, two) electron beam sources 22 are arranged along the shorter direction of the resin member P. In this example, the electron beam irradiation facility 12 viewed from the front of the entrance of the irradiation area A can be represented by FIG. 3A. However, in this case, part of FIG. 3A is omitted for ease of understanding. That is, it is assumed here that FIG. 3A shows only one electron beam source 22 (and one electron beam EB) instead of a plurality of overlapped electron beam sources 22 (and a plurality of electron beams EB).

Here, the two electron beam sources 22 are arranged along the shorter side direction of the resin member P, and as shown in FIG. 3A, the two electron beam sources 22 are moved in the longitudinal direction of the resin member P. In this way, the entire surface of the resin member P is irradiated with the electron beams EB. That is, unlike the example of FIG. 3B, in the example of FIG. 4, it is not necessary to move the electron beam sources 22 in the shorter direction of the resin member P.

Referring back to FIG. 1, description will be continued. A resin member P activated by the electron beam irradiation is stored in the storage facility 14. As described later, even if the resin member P irradiated with the electron beam is stored for about one month and dust and dirt adhered during storage are removed by a solvent or the like, the effectiveness of the electron beam irradiation is not lost.

The assembly facility 16 connects the metal member M and the activated resin member P. Specifically, the assembly facility 16 assembles the resin member P irradiated with the electron beam onto a metal body of an automobile. The metal member M and the resin member P connected in this manner are simultaneously coated with coating material at the coating facility 18 and simultaneously heated (dried) at the heating facility 20.

The coating facility 18 forms a coating film on the workpiece W by applying a coating material to the workpiece W. At the coating facility 18, for example, a coating material dissolved in a solvent is sprayed from a nozzle to coat the workpiece W with the coating material. When the solvent on the workpiece W is vaporized, a film of coating material (hereinafter referred to as coating film) is formed on the workpiece W. The application of the coating material and the vaporization of the solvent are usually performed in a coating booth.

The heating facility 20 heats the coating film formed on the workpiece W, thereby drying (curing, hardening) the coating film. The heating facility 20 is, for example, a heat treatment furnace.

In this embodiment, by irradiating the resin member P with the electron beam, the application of a primer to the resin member P and the drying of the primer become unnecessary. That is, a coating apparatus and a drying apparatus dedicated to primer coating are not required. A facility for the metal member M can be used as the coating facility 18 and the heating facility 20.

Further, the metal member M and the resin member P are simultaneously coated and dried as one workpiece W. As a result, the color matching between the metal member M and the resin member P is improved.

In order to improve the color matching between the metal member M and the resin member P based on the premise of the use of a primer, the following may be considered. That is, the booths of the coating facility and the heating facility are enlarged so that the metal member M and the resin member P can be simultaneously processed. After this simultaneous processes, the metal member M and the resin member P are connected (assembled) to each other. On the other hand, in this embodiment, after the metal member M and the resin member P are connected, a coating material is applied to the connected metal member M and the resin member P, and the applied coating material is dried. Therefore, in the present embodiment, a sufficient size of the coating facility 18 and the heating facility 20 is such that the metal member M (here, a metal body of an automobile) can be processed therein. That is, in this embodiment, it is not necessary to separately provide a space for the resin member P.

The advantage of activation with electron beams will be described below. That is, it is possible to activate the surface of the resin member P by using a method other than electron beam irradiation. Other techniques include, for example, flame treatment (treatment with plasmatic oxygen generated by the combustion of gas), plasma treatment, and UV (ultraviolet) irradiation. However, electron beam irradiation is preferable to other methods for the following reasons.

As one of the advantages of electron beam irradiation, it can be mentioned that the effect of activation by electron beam irradiation is high sustainability. This was confirmed by experiments, as follows. A polypropylene plate material was used as a plate material sample (i.e., the resin member P), and the plate material sample was irradiated with electron beams. Thereafter, a urethane coating material was applied to the plate material sample irradiated with electron beams, and further, the applied urethane coating material was dried at room temperature. Thus, a film of the urethane coating material is formed on the plate material sample. Thereafter, adhesion between the plate material sample and the coating material was checked. Specifically, whether the coating material has peeled off from the plate material sample was checked.

As irradiation conditions of the electron beam, the distance between the electron beam source 22 and the plate material sample was 10 mm, the acceleration voltage was 100 KV, and the irradiation dose was 150 kGy or 500 kGy.

On the other hand, in order to reduce the influence of ozone, the oxygen concentration is set at 300 ppm, which is smaller than the oxygen concentration in the atmosphere. When electron beams are emitted in the atmosphere, ozone is generated by the decomposition of oxygen in the atmosphere. Therefore, when the plate material sample is irradiated with the electron beam in the atmosphere, as a result, the treatment by the electron beam and the treatment by the ozone are applied to the plate material sample in a redundant manner. Therefore, in this experiment, the electron beam is emitted under a relatively low oxygen concentration so that ozone is substantially not generated. Thus, the effect of activation by electron beam irradiation itself was confirmed. However, it is rather preferable to activate the resin member P by irradiating the resin member P with an electron beam in the atmosphere. The higher the oxygen concentration is, the greater the effect of electron beam irradiation becomes. As a result, the treatment with ozone is included. However, the effect of ozone treatment does not reduce the effect of electron beam irradiation, but rather enhances the effect of electron beam irradiation.

Adhesion strength was compared between a plate material sample irradiated with electron beams and a plate material sample not irradiated with electron beams. As a result, the presence or absence of irradiation brought about a clear difference in adhesion strength.

Here, the adhesion force tended to decrease in accordance with the time H elapsed from the irradiation of the electron beam to the application of the coating material. However, even when the elapsed time H was one (1) month, the adhesion force was sufficiently large. During the passage of time H, the plate samples were stored in the atmosphere.

As another method, for comparison, a plate material sample was irradiated with an excimer laser (UV). Here, the plate material sample was irradiated for 5 seconds with an excimer laser beam having a wavelength of 172 nm and an irradiation intensity of 65 mW/cm², where the distance between the light source of the excimer laser and the plate material sample was 1 to 2 mm. A coating material was applied to the plate material sample in which time H had elapsed after irradiation with the excimer laser light, and the applied coating material was dried. Thereafter, adhesion between the plate material sample and the coating material was checked. As a result, it was found that the effect of the excimer laser irradiation lasted substantially for about one day after the irradiation and did not last for one week after the irradiation.

Thus, it was found that the effect of electron beam irradiation continues for about one month after irradiation, which is longer than that of excimer laser irradiation.

Another advantage of electron beam irradiation is that it is less affected by contact with other materials (e.g., solvents). That is, after the plate material sample irradiated with the electron beam is touched with a rubber glove or is washed with a solvent (IPA: isopropyl alcohol), coating material is applied to the plate sample. Even in such a case, the adhesion between the plate material sample and the coating material was good. Even in the case of the plate material sample that was irradiated with the electron beam one month ago, this result was obtained.

As described above, the effect of irradiating the resin member P with the electron beam continues for about one month after the irradiation, and this effect is hardly deteriorated even if another material contacts the resin member P. That is, the resin member P irradiated with the electron beam can be stored, and dust and dirt adhering to the resin member P during the storage can be removed by a solvent or the like.

The reason for this can be explained as follows. That is, it is considered that the electron beam reaches a deeper portion of the resin member P than oxygen plasma, light or the like used in other methods. The resin member P is radicalized by the electron beam, and the surface layer of the radicalized resin member P reacts with oxygen to form a surface active layer. Depending on the time having elapsed since the irradiation of the electron beam, or by contact of other materials with the surface active layer, the activity of the surface active layer may be lost. However, when the surface active layer loses its activity, a kind of radical from a deeper portion of the resin member P is replenished to the surface active layer. This radical reacts with oxygen in the atmosphere to regenerate the surface active layer. As described above, since the electron beam reaches a relatively deep portion of the resin member P, it is considered that the sustainability in the case of the electron beam irradiation is superior to other methods.

In addition, the electron beam irradiation can be performed more easily than other techniques (frame processing, plasma processing, and UV irradiation). That is, the effect of the electron beam irradiation does not greatly change even if the electron beam source 22 and the resin member P are farther part. Therefore, by moving the electron beam source 22, the entire surface of the resin member P can be easily irradiated with the electron beam. As the electron beam source 22 moves, the distance between the electron beam source 22 and the resin member P may change. However, in the case of the electron beam irradiation, the influence of the irradiation distance is small. On the other hand, in other methods, the influence of the irradiation distance is large. That is, in other methods, the effectiveness of the treatment tends to decrease rapidly as the distance between the treatment device and the sample increases.

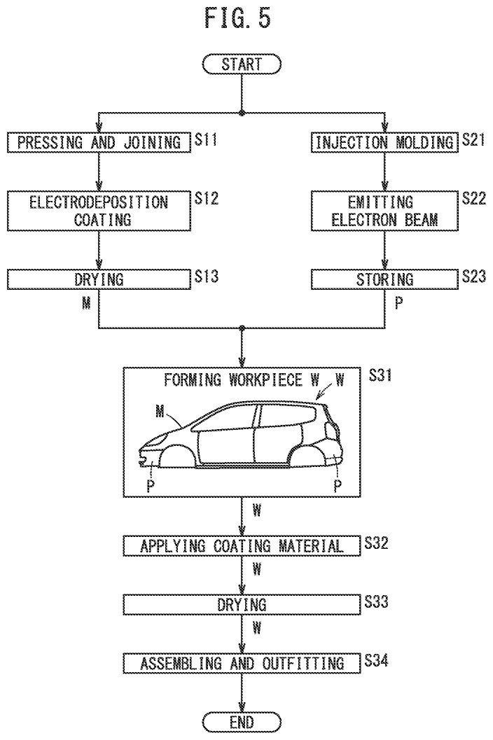

FIG. 5 is a flow chart showing a coating method according to an embodiment. Before the workpiece W is formed (step S31), the metal member M and the resin member P are processed separately. That is, the metal member M is formed by, for example, pressing a plate member and joining (e.g., welding) a plurality of pressed plate members (step S11). The prepared metal member M is subjected to a base coating. That is, the metal member M is immersed in the electrodeposition solution and a voltage is applied to the metal member M, whereby the metal member M is subjected to electrodeposition coating (step S12), and then the electrodeposition coating is dried (step S13). On the other hand, the resin member P is formed as a bumper or the like by injection molding (step S21). The electron beam irradiation facility 12 activates the surface of the resin member P by irradiating the resin member P with electron beams (step S22). Thereafter, the resin member P irradiated with the electron beam is stored in the storage facility 14 (step S23).

The assembly facility 16 connects the metal member M and the resin member P whose surface has been activated, to each other to form a workpiece W (step S31). The coating facility 18 applies a coating material to the workpiece W (step S32). The heating facility 20 dries the applied paint (step S33). Thereafter, by outfitting other members to the coated workpiece W, an automobile is produced (step S34).

As described above, in this embodiment, the following workpiece W is used. That is, the metal member M and the resin member P are connected to each other to be the workpiece W, and the surface of the resin member P has been activated by electron beam irradiation. Thus, the workpiece W can be coated without using a primer.

### Modification 1

The painting method according to the first modification will be described below. In the above embodiment, the resin member P irradiated with the electron beam is stored (steps S22 and S23). Alternatively, step S22 and step S23 may be interchanged. That is, the storage facility 14 may store the resin member P that has not been irradiated with the electron beam, and then the electron beam irradiation facility 12 may irradiate the resin member P with the electron beam before forming the workpiece W.

### Modification 2

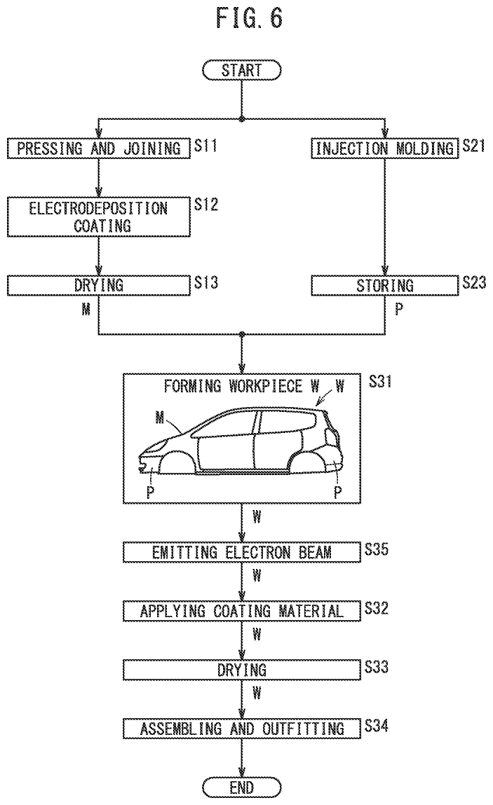

Hereinafter, the coating method according to the second modification will be described. FIG. 6 is a flow chart showing a coating method according to a second modification. Here, the assembly facility 16 forms a workpiece W by connecting the metal member M and the resin member P not irradiated with the electron beam, to each other (step S31). Thereafter, the electron beam irradiation facility 12 irradiates the resin member P of the workpiece W with the electron beam (step S35). In this manner, after the metal member M and the resin member P are connected to each other, the resin member P may be irradiated with the electron beam. In this case, the electron beam irradiation facility 12 may irradiate the metal member M (which is not originally an object to be irradiated) with the electron beam. Even if the metal member M is irradiated with the electron beam, the characteristics of the metal member M do not greatly change. However, from the viewpoint of efficiency, it is preferable to limit the electron beam irradiation toward the metal member M.

### Other Modifications

The present invention is not limited to the above-described embodiments, and various configurations can be adopted without departing from the gist of the present invention. In the coating system 10 shown in FIG. 1, the electron beam irradiation facility 12 is provided before the storage facility 14. On the other hand, in accordance with the first and second modifications, the electron beam irradiation facility 12 may be provided after the storage facility 14 or after the assembly facility 16.

Further, the above-described embodiment and the second modification have a step (step S23) of storing a molded and electron-beam-irradiated resin member P or a molded but not-yet-irradiated resin member P in the storage facility 14. On the other hand, the molded and electron-beam-irradiated resin member P or the molded but not-yet-irradiated resin member P may be directly transferred to the next step (formation of the workpiece W) without being stored.

### Invention Obtained from Embodiment

The invention that can be understood from each of the above embodiments will be described below.

[1] The coating method comprises the workpiece acquiring step of acquiring the workpiece (W) in which the metal member (M) and the resin member (P) the surface of which is activated by electron beam irradiation are connected to each other, and the coating step (S32) of applying the coating material to the metal member and the resin member of the workpiece. Thus, the coating material can be applied to the resin member of the workpiece without applying the primer to the resin member and drying the applied primer.
[2] The workpiece acquiring step includes the activation step (S22) of irradiating the resin member with an electron beam to activate the surface of the resin member, and the workpiece forming step (S31) of forming the workpiece by connecting the metal member and the resin member the surface of which has been activated, to each other. Thus, the metal member and the resin member can be processed together as a single workpiece.
[3] The workpiece acquiring step includes the storing step (S23) of storing the resin member the surface of which has been activated, and in the workpiece forming step, the metal member and the stored resin member are connected to each other. Thus, a workpiece can be formed by using the resin member that has been irradiated with electron beams and then stored.
[4] The workpiece acquiring step includes the connecting step (S31) of connecting the metal member and the resin member to each other, and the activation step (S35) of irradiating the resin member connected to the metal member with an electron beam to activate the surface of the resin member. Thus, the metal member and the resin member are connected to each other, and the connected member is irradiated with an electron beam to form a workpiece.
[5] The resin member is made up from polypropylene. Thus, it is possible to apply polypropylene without applying a primer.
[6] The workpiece is a body of an automobile, the metal member is a metal body, and the resin member is a bumper. Thus, the body of the automobile can be coated without using a primer.
[7] The body of the automobile includes the metal body, the bumper attached to the metal body and made up from the resin member, and the coating film covering the metal body and the bumper, wherein the bumper has the surface-activated layer in which the surface of the resin member has been activated, and the coating film is directly deposited on the surface activation layer. Thus, the bumper can be coated using the surface-activated layer.
[8] The surface-activated layer is a layer having a hydroxy group bonded to a carbon atom that constitutes the resin member. Thus, the resin member can be activated by using the hydroxy group as an active group.

The present invention is not limited to the above-described embodiment, and various modifications can be made without departing from the gist of the present invention.

What is claimed is:

1. A coating method comprising:
a workpiece acquiring step of acquiring a workpiece in which a metal member and a resin member a surface of which has been activated by electron beam irradiation are connected to each other; and
a coating step of applying a coating material to the metal member and the resin member of the workpiece.

2. The coating method according to claim 1, wherein
the workpiece acquiring step includes:
an activation step of irradiating the resin member with an electron beam to activate the surface of the resin member; and
a workpiece forming step of forming the workpiece by connecting the metal member and the resin member the surface of which has been activated, to each other.

3. The coating method according to claim 2, wherein
the workpiece acquiring step includes a storing step of storing the resin member the surface of which has been activated, and
in the workpiece forming step, the metal member and the stored resin member are connected to each other.

4. The coating method according to claim 1, wherein
the workpiece acquiring step includes:
a connecting step of connecting the metal member and the resin member to each other; and
an activation step of irradiating the resin member connected to the metal member with an electron beam to activate the surface of the resin member.

5. The coating method according to claim 1, wherein:
the resin member is made up from polypropylene.

6. The coating method according to claim 1, wherein:
the workpiece is a body of an automobile,
the metal member is a metal body, and
the resin member is a bumper.

7. A body of an automobile comprising:
a metal body;
a bumper attached to the metal body and made up from a resin member; and
a coating film covering the metal body and the bumper,
wherein
the bumper includes a surface-activated layer in which a surface of the resin member has been activated, and
the coating film is directly deposited on the surface-activated layer.

8. The body according to claim 7, wherein
the surface-activated layer is a layer including a hydroxy group bonded to a carbon atom that constitutes the resin member.
